(19) United States
(12) Patent Application Publication
(10) Pub. No.: US 2004/0255107 A1
(43) Pub. Date: Dec. 16, 2004

(54) Guided installation method supporting different operating systems and the recording medium

(76) Inventors: Win-Harn Liu, Taipei (TW); Jeff Song, Taipei (TW); Yu Li, Tianjin (CN)

Correspondence Address: BIRCH STEWART KOLASCH & BIRCH, PO BOX 747, FALLS CHURCH, VA, 22040-0747, US

(21) Appl. No.: 10/459,461

(22) Filed: Jun. 12, 2003

(51) Int. Cl. G06F 15/177; G06F 9/00

(52) U.S. Cl. 713/1

(57) ABSTRACT

A guided installation method supporting different operating systems (OS's) and the recording medium therefor are disclosed. The OS installation is divided into two steps: guided detection and installation. A user is guided by the recording medium to install different OS's. During the guided installation step, the config file of an OS is established according to the computer executable platform. During the installation step, the OS is installed according to the config file.

### BACKGROUND OF THE INVENTION

1. Field of Invention

The invention relates to a guided installation method for an operating system (OS) and the recording medium therefor. More explicitly, the invention relates to a method for a computer executable platform that enables different OS installations through the guide of the recording medium.

2. Related Art

The operating system (OS) is the core of a computer executable platform. For normal users, however, it is often a very difficult task to correctly install an OS on a computer. Currently, there are several automatic OS installation methods. One is done with the help of the recording medium provided by the OS manufacturer. In order for the installation process to be smooth and trouble-free, the manufacturer often include all kinds of possible drivers in the recording medium so that it can satisfy the hardware requirements of the computer. Another method is to install the OS using the recording medium provided by the manufacturer of the computer. During the installation process, an automatic installation document is generated according to the configuration of the hardware. It also prompts the user to insert a recording medium for standard installation provided by the producer for automatic installation of the OS. Therefore, the OS installation is usually very smooth. A third method also uses the recording medium provided by the computer manufacturer. The whole OS is made into a mirror file. The installation process is done by copying the mirror into the computer.

However, the above methods have some problems. For example, the first method requires the user to be equipped with knowledge about hardware and drivers to manually complete the installation if the computer hardware is special. The second method is that it only applies to the Windows-based OS provided by Microsoft. A common problem existing in the third method is that the installation recording medium provided by the manufacturer can only satisfy specific hardware environments. Once the hardware environment has any change, the installed OS may not be able to function correctly. Moreover, there is a variety of OS's on the market and each of them has different installation requirements. Therefore, the conventional automatic OS installation methods cannot satisfy user's needs. It is therefore a primary concern of all manufacturers to provide a method that supports different OS installations, simplifies the installation process, and guides the user to perform correct installations.

### SUMMARY OF THE INVENTION

In view of the foregoing, the invention provides a guided installation method for different OS's and the recording medium therefor. An objective of the invention is to simplify the OS installation process on a computer executable platform through a guided detection step given in the recording medium. Afterwards, a common installation step supports the installation of different OS's so that the invention can be widely applied to all kinds of OS installation on a computer.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the operation according to the disclosed guided installation method for different OS's and the recording medium;

FIG. 2 is a main flowchart of the invention; and

FIGS. 3a to 3c are detailed flowcharts of the invention.

### DETAILED DESCRIPTION OF THE INVENTION

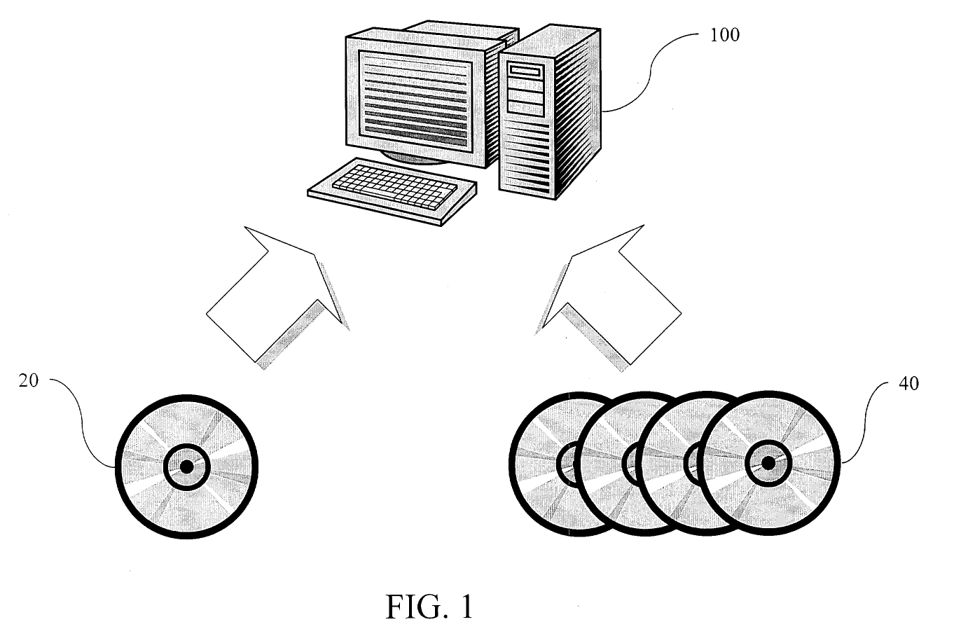

With reference to FIG. 1, the disclosed guided installation method for different OS's achieves the complete OS installation process by executing a guided detection step and an installation step in recording medium (including a recording medium for detecting 20 and a recording medium for installation 40).

The guided detection step performs authorization and verification (checking whether the recording medium obtained by the user is legal), and provides some basic settings (such as system time zone, system time, etc). After the user selects the OS type to be installed, the corresponding guide procedure starts. The installation step prompts the need of and detects recording medium, copies programs, and installs the OS on the computer executable platform 100.

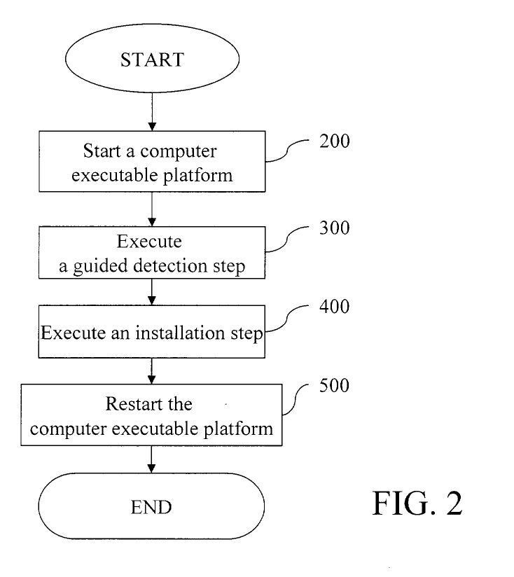

FIG. 2 shows the flowchart of the disclosed guided installation method and the recording medium therefor. The main operation of the invention can be divided into four parts. First, a computer executable platform 100 is started (step 200). Then the system performs the guided detection step according to the recording medium for detecting 20 (step 300). According to the guided detection result, an appropriate recording medium for installation 40 is selected to perform the OS installation (step 400). Finally, the computer executbale platform is restarted, finishing the complete guided OS installation (step 500).

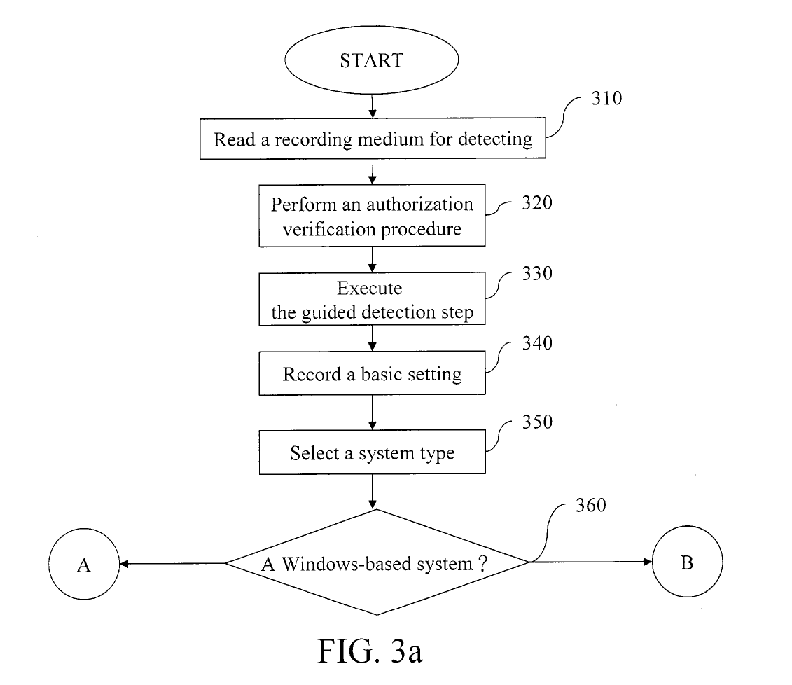

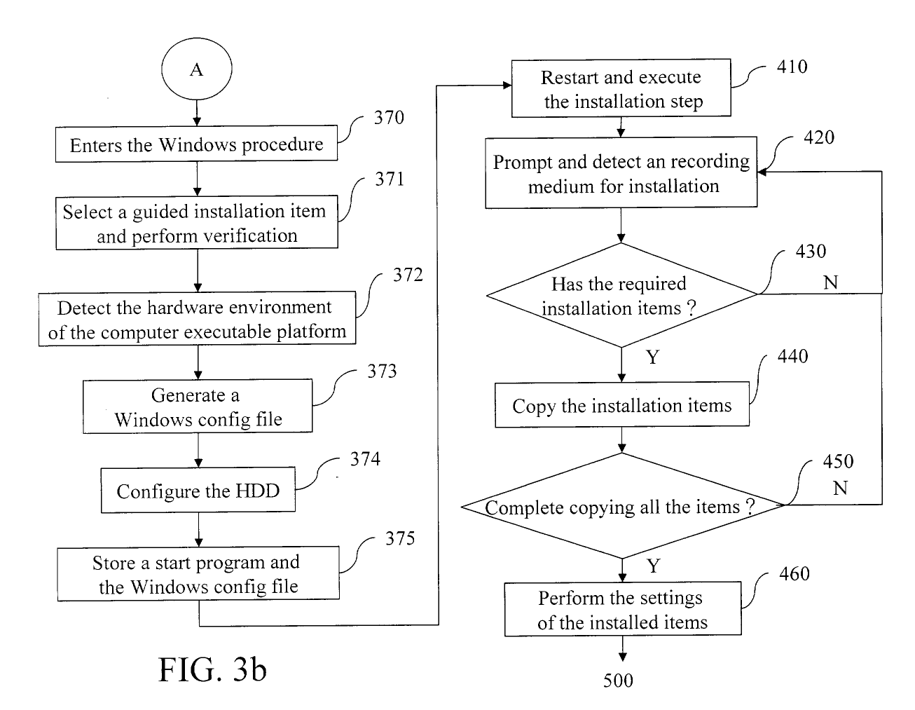

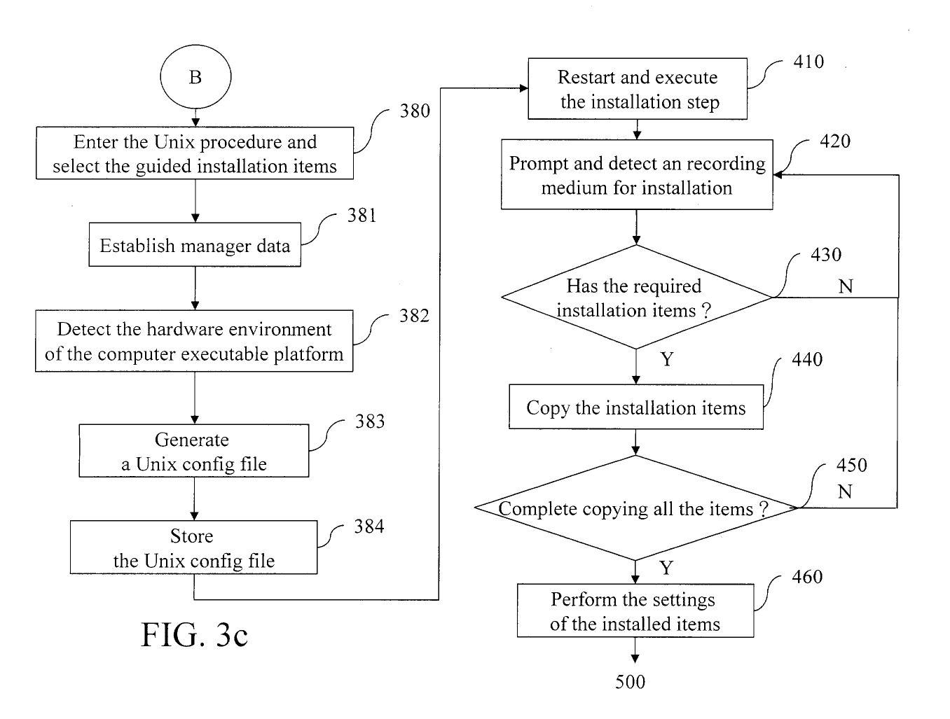

We use FIGS. 3a to 3c to further explain the detailed procedure in the disclosed method. FIG. 3a shows the procedure of a common guided detection step. FIG. 3b shows the guided detection and installation of a Windows-based OS. FIG. 3c shows the guided detection and installation of a Unix-based OS.

In FIG. 3a, the computer executable platform 100 starts to read the recording medium for detecting 20 (step 310). After authorization verification (step 320), the computer performs the guided detection step (step 330). It first prompts the user to perform some basic settings and records the setting preference (step 340). It then prompts the user to select an OS type to be installed (step 350). The common OS's can be divided into two types: Windows-based and Unix-based. The guided detection and installation steps of these two types of OS's are different. If the user selects to install a Windows-based OS (step 360), the procedure continues to FIG. 3b. If the user selects to install a Unix-based OS, the procedure continues to FIG. 3c.

If the user selects to install a Windows-based OS, the guided detection step runs the Windows-based procedure (step 370). At the moment, the system further prompts the user to select items to be installed (such as Windows XP, Windows 2000, Windows ME, etc). After the selection, the system performs verification to make sure that the item to be installed is a legal copy (step 371). After verification, it starts to detect the hardware environment of the computer executable platform 100 (step 372). After the detection, the result is recorded and a Windows config file is generated (step 373). The config file includes: the storage locations of all installation items and files related to the installation step. Afterwards, the system starts a hard disk drive (HDD) configuration step, which includes disk partition and format (step 374). The partition and format settings can be determined by the user. Otherwise, the system follows the default settings by Windows. Once the HDD is configured, the system provides initialization items and a Windows config file, which are also stored in the HDD (step 375). The computer executable platform 100 then restarts and enters the installation step (step 410). According to the items that are recorded in the config file for installation, the system prompts and detects the recording medium for installation 40 that user put in (step 420), determining whether the recording medium for installation 40 has the installation items required by the user (step 430). If the installation items are not found, step 420 continues to prompt the user to put in the right recording medium until the correct one is detected. Once the correct recording medium for installation 40 is found, the copy action of the installation items starts (step 440). During the copy process, the installation step continues detecting whether all items have been copied (step 450). If not finished, step 420 continues until all copy actions finished. Once all the installation items are copied, the system starts the settings of the installed items (step 460). Finally, the procedure goes back to step 500. The computer executable platform 100 is restarted, completing the guided installation of the Windows-based OS.

If the user wants to install a Unix-based OS, the guided detection step runs the Unix-based procedure and prompts the user to select items to be installed (such as Red Hat, Slackware, Debian, or SuSE) (step 380). After the selection, the user is prompted to perform the settings of manager data, such as manager name, manager password, etc (step 381). The system detects the hardware environment on the computer executable platform 100 (step 382). A Unix config file is generated after the detection (step 383). The config file also contains the storage locations of all items to be installed and files related to the installation step. The config file is stored in the HDD (step 384). Afterwards, the computer executable platform 100 restarts and enters the installation step (step 410). According to the items that are recorded in the config file for installation, the system prompts and detects the recording medium for installation 40 the user put in (step 420), determining whether the recording medium for installation 40 has the installation items required by the user (step 430). If the installation items are not found, step 420 continues to prompt the user to put in the right recording medium until the correct the recording medium for installation 40 is detected. Once the correct one is found, the copy action of the installation items starts (step 440). During the copy process, the installation step continues detecting whether all items have been copied (step 450). If not finished, step 420 continues until all copy actions finish. Once all the installation items are copied, the system starts the settings of the installed items (step 460). Finally, the procedure goes back to step 500. The computer executable platform 100 is restarted, completing the guided installation of the Unix-based OS.

### EFFECTS OF THE INVENTION

The disclosed guided installation method for different OS's and the recording medium therefor simplifies the installation procedure of an OS through a common guided detection step. Users without professional skills can easily perform the installations of many OS's.

On the other hand, the installation step of the invention can be performed according to predetermined settings, automatically copying items satisfying the requirements of the computer. This greatly reduces the possibility of troubles due to specialty and variety of hardware on the computer. This also increases the applicability of the invention.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A guided installation recording medium that supports different operating systems (OS's) for storing computer programs that guide the installation and relate to the OS, the recording medium comprising:
a recording medium for detecting, which enables a computer executable platform to execute a guided detection step; and
a plurality of recording medium for installation, which enables the computer executable platform to perform an installation step.

2. The recording medium of claim 1, wherein the execution of the guided detection step includes authorization verification, recording a basic setting, selecting a system type, and a guided step for the system type.

3. The recording medium of claim 1, wherein the system types include a Windows-based system and a Unix-based system.

4. The recording medium of claim 1, wherein the execution of the installation step includes prompting for and detecting the recording medium for installation, copying installation items, restarting the computer executable platform, and executing an installation step.

5. A guided installation method that supports different OS's, comprising the steps of:
starting a computer executable platform;
executing a guided installation step;
executing an installation step; and
restarting the computer executable platform.

6. The method of claim 5, wherein the execution of the guided detection step includes authorization verification, recording a basic setting, selecting a system type, and a guided step for the system type.

7. The method of claim 5, wherein the system types include a Windows-based system and a Unix-based system.

8. The method of claim 7, wherein the guided installation step for the Windows-based system further comprises the steps of:
selecting a guided installation item and performing verification;
detecting the hardware environment of the computer executable platform;
generating a Windows config file;
executing a hard disk drive (HDD) configuration step; and
storing a starting program and the Windows config file.

9. The method of claim 8, wherein the Windows config file includes an installation item and an installation step.

10. The method of claim 7, wherein the guided installation step for the Unix-based system further comprises the steps of:
establishing manager data;
executing a HDD configuration step;
detecting the hardware environment of the computer executable platform;
generating a Unix config file; and
storing the Unix config file.

11. The method of claim 10, wherein the Unix config file includes an installation item and an installation step.

12. The method of claim 5, wherein the installation step further includes the steps of:
prompting for and detecting an recording medium for installation;
copying the installation item; and
restarting the computer executable platform and executing the installation step.
